(19) United States
(12) Patent Application Publication
(10) Pub. No.: US 2025/0239724 A1
(43) Pub. Date: Jul. 24, 2025

(54) AIR BREATHER VENTS FOR BATTERY PACK POTTING

(71) Applicant: GM GLOBAL TECHNOLOGY OPERATIONS LLC, Detroit, MI (US)

(72) Inventors: Anthony Michael COPPOLA, Rochester Hills, MI (US); Jake ZUCKERMAN, Royal Oak, MI (US); Sean S. LINCOLN, Berkley, MI (US); Michael MAES, Berkley, MI (US); Mohammad Hamza KIRMANI, Troy, MI (US)

(21) Appl. No.: 18/421,271

(22) Filed: Jan. 24, 2024

(51) Int. Cl. H01M 50/367; H01M 50/209; H01M 50/233

(52) U.S. Cl. CPC H01M 50/367; H01M 50/209; H01M 50/233

(57) ABSTRACT

A battery module includes a housing including a sidewall structure, a top shear plate and a bottom shear plate. A vent tray assembly is disposed within the housing and includes a plurality of cell trays and a plurality of vent trays that combine to define a plurality of vent channels therebetween. The cell trays include a base plate having a plurality of vent openings in communication with one of the plurality of vent channels, the vent tray assembly including an air vent covered with a semi-permeable media. A plurality of battery cells each include an end with a vent that is aligned with one of the vent openings in the base plate in the cell tray. A potting foam is dispersed within the housing and between the batteries.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a method for filling a battery pack with expanding foam potting by venting air outside of the potted region.

Cylindrical cell battery packs typically require encapsulating potting material around the cells to provide structural support and thermal runaway propagation protection. Automotive battery packs have utilized a ventilation system that allows individual battery cells to vent through a passage system that isolates the passages from the remaining cells of the battery pack. The vent system must remain open for gas to traverse during a thermal event in order to allow the gas to reach the pack's vent port. Accordingly, during the potting process, the potting needs to be prevented from entering the vent system.

While foam potting is used in several automotive battery packs on the market, voids are common place. Voids can occur as a result of either underfill or entrapped air. The presence of voids may adversely affect thermal runaway performance by allowing migration of inflamed gas between cells or in areas of high voltage, as well as reduce structural performance due to reduced material and uneven distribution. The foam potting is typically composed of a polyurethane, but could also be an epoxy, silicone, or other resin. Potting is dispensed as a liquid resin then expands due to a chemical reaction. After some time, the material is fully expanded and hardens to form a foam plastic material. During expansion, the foam dispenses air, which must be removed from the battery pack to avoid voids in the potting material. However, the air vent ports run the risk of allowing foamed resin to pass, which could result in blockages of the vent areas that must remain without potting.

### SUMMARY

According to the principles of the present disclosure, potting is dispensed around the and within the battery module. Air is pushed towards strategically located vent passages formed through overlapping joints in the vent tray assembly.

According to an aspect of the present disclosure, a battery module includes a housing including a sidewall structure, a top shear plate and a bottom shear plate. A vent tray assembly is disposed within the housing and includes a plurality of cell trays and a plurality of vent trays that combine to define a plurality of vent channels therebetween. The cell trays include a base plate having a plurality of vent openings in communication with one of the plurality of vent channels, the vent tray assembly including an air vent that is covered with a semi-permeable media. A plurality of battery cells each include an end with a vent that is aligned with one of the vent openings in the base plate in the cell tray. A potting foam is dispersed within the housing and between the batteries.

According to a further aspect, the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

According to a further aspect, the battery cells are one of cylindrical and prismatic type.

According to a further aspect, the air vent includes a plurality of air vents located in a center region of the battery housing.

According to a further aspect, the vent tray includes a base plate and a plurality of pairs of parallel ribs that align with a respective one of a plurality of parallel ribs of the cell tray to define the plurality of vent channels.

According to a further aspect, the air vent extends through a staked hollow protrusion extending from the base plate of the cell tray.

According to a further aspect, the staked hollow protrusion extends through an opening in a layer of mica disposed against the base plate of the cell tray.

According to a further aspect, the air vent includes a tapered opening.

According to a further aspect, the air vent includes an insert received in an opening in the cell tray and the insert including an opening therethrough.

According to a further aspect, the semi-permeable media include one of an open cell foam, felt, woven fabric, knit fabric, non-woven fabric and paper.

According to another aspect, a method of making a battery module includes inserting a plurality of battery cells into an upside down housing having a top shear plate and a sidewall structure. A vent tray assembly is placed on top of the batteries, the vent tray assembly includes a plurality of cell trays and a plurality of vent trays that combine to define a plurality of vent channels therebetween, the cell trays each include a base plate having a plurality of vent openings in communication with one of the plurality of vent channels, the cell trays including an air vent covered with a semi-permeable media. A potting foam is dispensed into the housing in a pattern that causes the potting foam to reach the air vent after substantially all of the air within the housing has passed through the air vent.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of a portion of a battery pack with venting for a potting region according to the principles of the present disclosure;

FIGS. 2A-2C illustrate a process for forming an air vent in a vent tray assembly according to the principles of the present disclosure;

FIGS. 3A-3C illustrate a process for forming an air vent in a vent tray assembly according to a second embodiment;

FIG. 4 is a cross-sectional view of an air vent in the vent tray assembly according to a third embodiment; and

FIG. 5 is a schematic view of a battery pack illustrating an example of the potting dispense locations and the air vent locations according to the principles of the present disclosure.

In the drawings, reference numbers may be reused to identify similar and/or identical elements.

### DETAILED DESCRIPTION

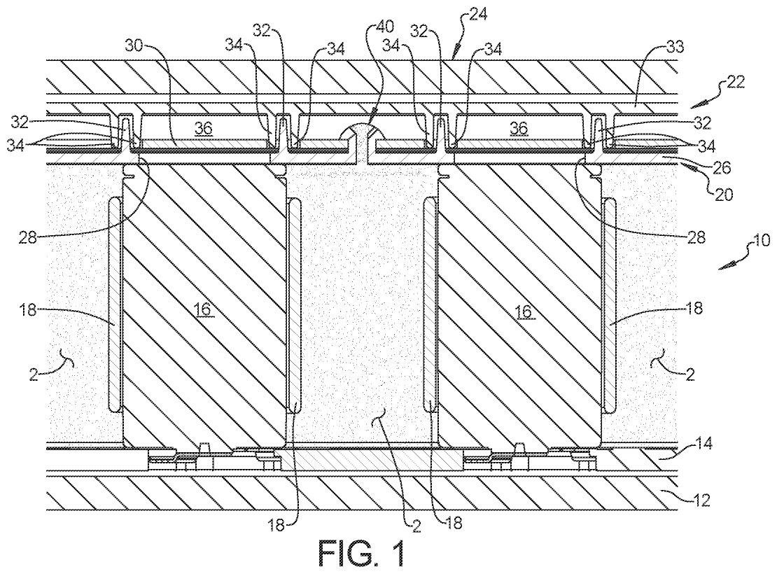

With reference to FIG. 1, a partial cross-sectional view of a battery module 10 is shown in an upside-down state for receiving potting and including an upper shear plate 12 and an integrated circuit board 14. A plurality of battery cells 16 are disposed on top of the integrated circuit board 14. A plurality of cooling ribbons 18 can be disposed between the battery cell rows for cooling the battery cells 16. A cell tray 20 is disposed on top of the battery cells 16 and a vent tray 22 is engaged with the cell tray 20. A bottom shear plate 24 is on top of the vent tray 22 when the battery module 10 is upside down as shown in FIG. 1.

The cell tray 20 includes a base plate 26 having a plurality of vent openings 28 that each align with one of the battery cells 16. A layer of mica 30 is disposed over the vent openings 28. The cell tray 20 further includes a plurality of parallel ribs 32 extending from the base plate 26. The vent tray 22 includes a base plate 33 and a plurality of pairs of parallel ribs 34 that each receive one of the plurality of parallel ribs 32 of the cell tray 20 therebetween. The ribs 32 of the cell tray 20 and the ribs 34 of the vent tray 22 combine to define a plurality of parallel vent channels 36 that align with a plurality of the vent openings 28. The parallel vent channels 36 allow the individual battery cells 16 to vent through the layer of mica 30 by bursting the mica and the vent openings 28 while the vent channels 36 isolate the remaining battery cells 16 of the battery pack 10.

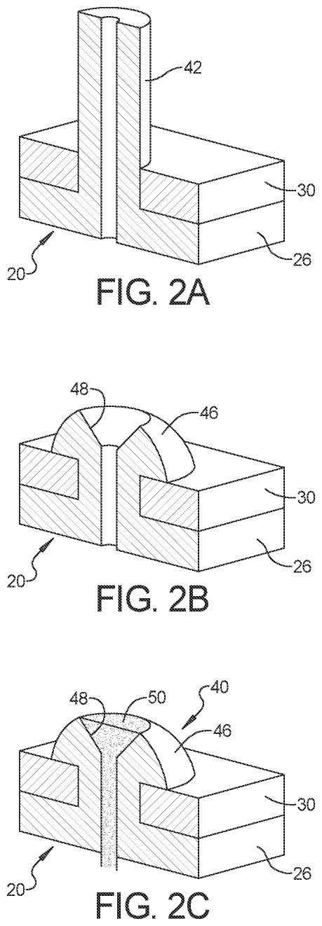

An air vent 40 is provided through the base plate 26 to allow air to escape the housing when the potting 2 is dispensed into the housing. In particular, the potting can be dispensed as a resin and as it reacts with air, the resin expands into a foam 2. The foam displaces the air within the module 10 and the air is removed through the air vent 40. With reference to FIG. 2A-2C, the air vent 40 can be formed by forming a hollow tubular protrusion 42 that extends from the base plate 26 of the cell tray 20. The hollow tubular protrusion 42 includes a passage 44 therethrough. The hollow tubular protrusion extends through an opening in the mica 30, as shown in FIG. 2A. As shown in FIG. 2B, the hollow tubular protrusion 42 can be heat staked to hold the mica 30 in place. The staked protrusion 46 can be formed with a conical seat 48 that receives a semi-permeable media 50 such as open cell foam, felt, woven or knit fabric, non-woven, paper or other selected membrane material, as shown FIG. 2C.

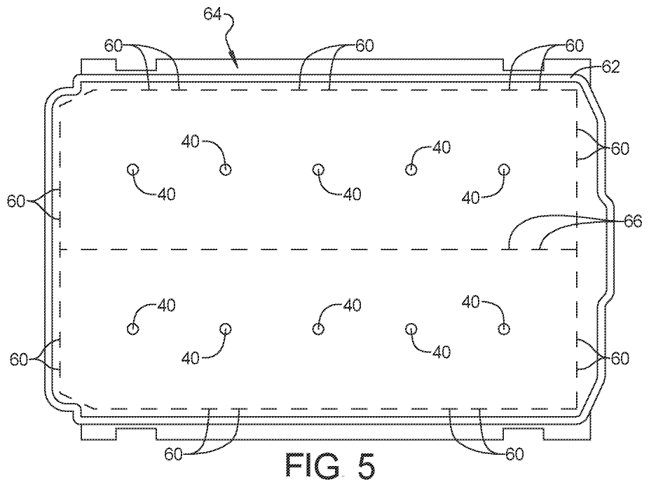

With reference to FIG. 5, the battery module 10 is schematically shown with the potting dispense locations illustrated at numerous locations 60 around a perimeter of a sidewall structure 62 and down a center of the housing 64. Additional dispense locations 66 can be provided within an intermediate portion of the housing 64, as shown. As the potting 2 is dispensed as a resin, it chemically changes to an expanding foam that displaces the air from the housing 64. As the foam expands the air is expelled from the air vent(s) 40 into the channels 36. As shown in FIG. 5, the air vents 40 are located at a center location and the potting 2 dispense locations 60, 66 are located to allow the potting foam 2 to expand and expel substantially all of the air from the housing 64 prior to the potting foam reaching the air vents 40. The semi-permeable media 50 allows air to pass through, but blocks the passage of potting foam that is injected into the battery module 10.

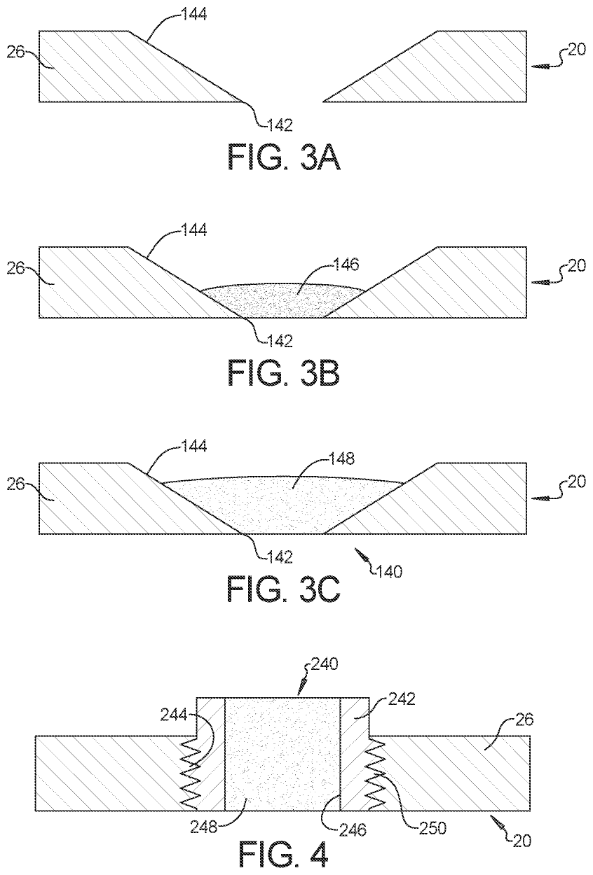

With reference to FIGS. 3A-3C, an alternative method of forming the air vents 140 is shown. As shown in FIG. 3A, an opening 142 is formed through the base plate 26 of the cell tray 20. The opening 142 can include a tapered surface 144 surrounding the opening 142. As shown in FIG. 3B, a liquid resin 146 is dispensed into the tapered surface 144 surrounding the opening 142. The viscosity and surface tension of the liquid resin 146 prevents the resin from dripping through the opening 142. With reference to FIG. 3C, the resin 146 foams in place and cures to form an open cell foam 148 that provides a selective valve that allows air to escape the housing during the dispersion of the potting 2 into the vent channels 36 and prevents the potting 2 from passing through.

With reference to FIG. 4, an alternative air vent 240 is shown extending through the base plate 26 of the cell tray 20. The air vent 240 is formed by an insert 242 that is received in an opening 244 in the base plate 26 of the cell tray 20. The insert 242 includes an opening 246 therethrough with an open cell foam 248 or other semi-permeable media disposed in the opening 246. The insert 242 can include an external thread 250 that can be received in a threaded opening 244, or can otherwise be secured within the opening 244 by press-fit, heat staking, or adhesive. The semi-permeable material within the air vent 240 allows air to pass through, but blocks the passage of potting foam that is injected into the battery module 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery module, comprising:
a housing including a sidewall structure, a top shear plate and a bottom shear plate;
a vent tray assembly disposed within the housing and including a plurality of cell trays and a plurality of vent trays that combine to define a plurality of vent channels therebetween, the cell trays including a base plate having a plurality of vent openings in communication with one of the plurality of vent channels, the vent tray assembly including an air vent covered with a semi-permeable media;
a plurality of battery cells each having an end with a vent that is aligned with one of the vent openings in the base plate in the cell tray; and
a potting foam dispersed within the housing and between the batteries.

2. The battery module according to claim 1, wherein the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

3. The battery module according to claim 1, wherein the battery cells are one of cylindrical and prismatic type.

4. The battery module according to claim 1, wherein the air vent includes a plurality of air vents located in a center region of the battery housing.

5. The battery module according to claim 1, wherein the vent tray includes a base plate and a plurality of pairs of parallel ribs that align with a respective one of a plurality of parallel ribs of the cell tray to define the plurality of vent channels.

6. The battery module according to claim 1, wherein the air vent extends through a staked hollow protrusion extending from the base plate of the cell tray.

7. The battery module according to claim 1, wherein the staked hollow protrusion extends through an opening in a layer of mica disposed against the base plate of the cell tray.

8. The battery module according to claim 1, wherein the air vent includes a tapered opening.

9. The battery module according to claim 1, wherein the air vent includes an insert received in an opening in the cell tray and the insert including an opening therethrough.

10. The battery module according to claim 1, wherein the semi-permeable media include one of an open cell foam, felt, woven fabric, knit fabric, non-woven fabric and paper.

11. A method of making a battery module, comprising:
inserting a plurality of battery cells into an upside down housing having a top shear plate and a sidewall structure;
placing a vent tray assembly on top of the batteries, the vent tray assembly including a plurality of cell trays and a plurality of vent trays that combine to define a plurality of vent channels therebetween, the cell trays each including a base plate having a plurality of vent openings in communication with one of the plurality of vent channels, the cell trays including an air vent covered with a semi-permeable media;
dispersing a potting foam into the housing in a pattern that causes the potting foam to reach the air vent after substantially all of the air within the housing has passed through the air vent.

12. The method according to claim 11, wherein the cell trays include a plurality of parallel ribs extending from the base plate of the cell trays and the vent trays include a base plate and a plurality of parallel ribs that extend from the base plate of the vent trays, and the plurality of parallel ribs of the cell trays and the plurality of parallel ribs of the vent trays combine to form the plurality of vent channels.

13. The method according to claim 11, wherein the potting foam is dispensed around a perimeter of the housing.

14. The method according to claim 11, wherein the air vent is in a center region of the housing.

15. The method according to claim 11, wherein the battery cells are one of cylindrical and prismatic type.

16. The method according to claim 11, wherein the air vent extends through a staked hollow protrusion extending from the base plate of the cell tray.

17. The method according to claim 11, wherein the staked hollow protrusion extends through an opening in a layer of mica disposed against the base plate of the cell tray.

18. The method according to claim 11, wherein the air vent includes a tapered opening.

19. The method according to claim 11, wherein the air vent includes an insert received in an opening in the cell tray and the insert includes an opening therethrough.

20. The method according to claim 11, wherein the semi-permeable media include one of an open cell foam, felt, woven fabric, knit fabric, non-woven fabric and paper.
